(19) United States
(12) Patent Application Publication
(10) Pub. No.: US 2004/0238985 A1
(43) Pub. Date: Dec. 2, 2004

(54) Masking article for use in vehicle manufacturing

(76) Inventor: Volker Beckord, Hannover (DE)

Correspondence Address: Patrick W Rasche, Armstrong Teasdale, Suite 2600, One Metropolitan Square, St Louis, MO, 63102, US

(21) Appl. No.: 10/482,754

(22) PCT Filed: Jun. 29, 2001
(86) PCT No.: PCT/EP01/07501

(51) Int. Cl. B29B 17/00; B05D 5/00

(52) U.S. Cl. 264/37.33; 427/282

(57) ABSTRACT

The present invention relates to a processing means 1 for masking regions of a vehicle during the painting operation. The invention also relates to a method of manufacturing and recycling processing means 1 of this kind, as well as to a method of masking regions of a vehicle during the painting operation with such a processing means 1. It is the objective of the present invention to make available a recyclable processing means 1 of the kind cited above, which under the conditions of a painting operation exhibits a shape, stability and firmness such that its use provides advantages regarding economy and quality as well as ecological considerations. This objective is achieved by a processing means 1 for masking regions of a vehicle that consists of a plastic material and can be placed on a cathodal dip-priming coat covering the flange 2 around openings in a vehicle body or vehicle module, so as to produce a form-fitting seal. After removal of the processing means 1 from the vehicle-body flange 2, the result is a good adherence and ageing-resistant bonding quality between an adhesive 4 and a window pane 3. The processing means in its painted state can be simply and ecologically recycled and re-used.

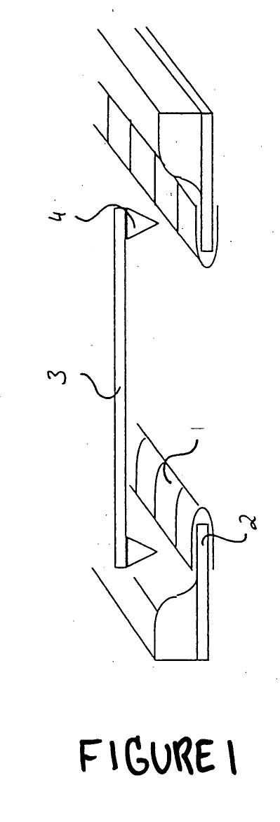

The invention relates to a processing means for masking regions of a vehicle during the painting operation. The invention also relates to a method of manufacturing and recycling processing means of this kind, as well as a method of masking regions of a vehicle with such processing means during the painting operation.

The painting operation in automobile production lines is at present one of the most technically demanding situations for the application of paint. The most important requirements are associated with the colour and the degree of shine thereby achieved, and with protection of the metal surfaces from external influences. The desired properties of the painted surface are achieved by application in successive layers, each of which has a different function. That is, initially cathodal electrolytic dip-priming (CDP) is performed, in which a layer of material to protect against corrosion is applied by immersion of the raw vehicle body and then, e.g., cured in a drying oven at temperatures up to 220° C. Only after this has occurred does the primed vehicle body proceed to the actual painting, in which various coats are applied. The first is a filler coat to compensate for unevenness in the underlying surface and as a protection from impacts against stones. The next step is application of a pigmented coat to provide colour and effect, and finally a clear finish is applied to protect against external influences. The actual painting process, comprising the steps subsequent to the CDP, is carried out at temperatures as high as ca. 170° C.

Until now it has been customary to attach other components to the body of a vehicle only after the painting sequence has been completed. In particular, for industrial-scale manufacture the glass panes (front windscreen, back window, fixed side windows) are customarily inserted and sealed into place at the assembly site under robotic control (direct glazing). The adhesive used to fix the panes is first applied as a bead all around the edges of the window pane, before this region is brought into contact with the installation site on the body (the window flange) and pressed into position. The structural joint between the pane and the body thus serves both for stabilization, in the sense that the body is resistant to torsion, and also to divert the forces produced in case of a crash.

Because all of the coatings sprayed on during the painting process, including the filler and the outer lacquer layer, are applied as desired by the client, it is necessary for the pane adhesive to adhere well to many different covering lacquers (or paints). The structural connection between the pane and the vehicle body, however, is not satisfactory in the case of an assembly such that lacquered surfaces are present, because the lacquered construction cannot itself absorb the structural forces that are imposed, especially in a crash. The optimal way to achieve a good result regarding adhesion between the vehicle-body flange and the pane adhesive, therefore, is to attach the window by adhesive to the CDP coating, eliminating the filler material and the covering paints with their associated structural weaknesses. A structural adhesion of this kind contributes to the trend towards a lightweight construction and an increased torsional stability of the body. However, this method also requires an appropriate masking of the body flange after it has emerged from the CDP process, to keep this region isolated from the paint layers applied during the subsequent steps. With such masking, faultless adhesion of the pane adhesive to the CDP-coated flange is achieved.

In one of the known methods for achieving pane adhesion, the body flange is masked with an adhesive tape or with an organic mass such as a PVC plastisol. The plastisol is gelled, e.g., by means of IR radiators or in a PVC oven, so that it acquires a solid consistency. At the end of the painting operation and before the panes are mounted, the flange masking is usually removed manually and thrown away, and the glass is applied directly to the CDP-coated flange. Hence neither the plastisol nor the adhesive tape can be recycled, which makes it necessary to dispose of considerable amounts of refuse produced by this method.

It is the objective of the present invention to make available recyclable processing means for masking regions of a vehicle during the painting operation, the shape, stability and solidity of which are such that when they are used under the conditions prevailing in such an operation, they provide advantages with respect to economy and quality as well as to ecological considerations.

This objective is achieved by a processing means for masking regions of a vehicle in which the processing means is made of plastic and can be placed on the dip-primed surface of the flange surrounding the opening of a vehicle body or vehicle module in such a way as to produce a form-fitting seal.

The layout of the masking is constructed specifically for the particular area of application concerned, and depends on the type of vehicle and the shape of the window opening. The masking is pressed against the body flange, or pulled over it, and covers it completely. This covering is form-fitting and cannot be penetrated by paint, so that the CDP coat here is not painted and provides an optimal surface for attachment by way of adhesive during direct glazing. The processing means is made of a plastic material, so that after it has been used, even if paint is adhering to it, it can be ground up as a whole and ultimately returned for re-use in an injection-moulding procedure.

Advantageous further developments of the processing means in accordance with the invention are given in the following subordinate claims 2-4.

It is particularly advantageous for the processing means to be made of a thermally stable plastic, suitable for long-term use at a temperature of at least 170° C. These special plastics, which exhibit the required properties and can be used for injection moulding, have been found only after detailed practical trials. Plastics in this category include, e.g., polysulfone, poly(arylether)ketone, polyamides etc., as presented in the plastics compendium Vogel Fachbuch, 4th edition 1996, by Dr. A. Frank, ISBN 3-8023-1589-8.

Particularly suitable for such a processing means are plastics reinforced with fibres of glass, kevlar or the like. The best plastic with respect to purchase costs, recyclability, injection moulding (optimal flow behaviour) and mechanical properties, even at temperatures as high as those in the heat-curing oven, has proved to be glass-fibre-reinforced polyamide.

The advantages cited above can be demonstrated in particular for processing means, the plastic material of which is reinforced by fillers in the ratio of 0.1 to 40%. Within this range of filler content, depending on the requirements regarding good flow behaviour during injection moulding and an appropriate shape stability and firmness of the processing means during painting processes, a desirable optimum can be obtained.

The objective is also achieved by a method of producing and recycling processing means for masking regions of a vehicle during the painting operation comprising steps in which a) the processing means are manufactured by injection moulding; b) after each time they are used, the processing means are ground up while still in the painted state; c) the resulting powder is returned to be used again as raw material in the injection procedure to manufacture the processing means.

The processing means in accordance with the invention is first manufactured by injection moulding and after each use is ground up in the painted state, the resulting powder being directly re-usable for the manufacture of processing means. Because the special plastics are employed, the whole processing sequence is simplified. After such processing means have been used, there is no longer any need to sort them according to type, because they can be ground up after each use, while still in the painted state, and hence can be supplied as bulk material for injection moulding. In particular, a consequence is that there are no costs for handling or for the restoration of functionality that would otherwise sometimes be necessary.

Furthermore, the concept in accordance with the invention is also ecologically sound. No mechanical, thermal or chemical operation is required for paint removal, because the processing means in accordance with the invention can be supplied for injection molding after being ground up while in the painted state.

It is also economical to employ the processing means in accordance with the invention. The user, in particular the vehicle assembler, is not encumbered with the responsibility for making them available because this task is assumed by the subcontractors, i.e. the injection-moulding facility whose main activity is to grind up the bulk material and make use of the recycled product.

Advantageous further developments of the method are presented in the following subordinate claims 6 and 7.

When injection moulding is employed in a recycling system, it is preferred to add a certain amount of original raw material. This can be useful in particular when the quality of the paint-contaminated plastic material to be recycled is no longer satisfactory. By addition of the original raw material, the masking function can be preserved, with the advantages cited above.

The amount of original raw material added is preferably about 10%. This slight admixture of the original raw material guarantees, in particular, that the recycled material can be used several times without sacrificing its mechanical and thermally resistant properties.

The objective of the present invention is also achieved by a method of masking regions of a vehicle during the painting process, in which a processing means according to one of the preceding claims is applied to a CDP coating on the vehicle-body flange or the vehicle-module openings in such a way as to produce a form-fitted seal, and after the painting process has been completed, is removed again.

As a result, after the final painting it is possible to attach the pane to the dip-primed surface by adhesive, which avoids the problem of structurally weak points in the filler material and in the finishing lacquer. By this kind of structural adhesion of the window to the vehicle body, in particular the torsional stiffness of the body is increased and forces produced in case of a crash are better dissipated. Thus the trend towards lightweight construction of vehicle bodies is assisted.

The processing means in accordance with the invention can be employed not only to assist subsequent attachment of panes by adhesive, but also as masking for the similar attachment of other modules, such as front flaps, rear flaps, mud guards, side walls etc.; here, again, practically 100% of the painted plastics can be re-used for injection moulding.

The processing means in accordance with the invention is explained below with reference to a FIGURE.

The single FIGURE provided shows a processing means 1 for masking a vehicle-body flange 2, which is sealed off by form-fitting of the processing means 1. The vehicle-body flange 2 in this case is disposed around the periphery of an opening in which a window pane 3 is to be installed, having been provided in the region of its edges with a ridge of adhesive 4. Because it has been shielded by the processing means 1, only the CDP coating has been applied to the flange 2 and not the paint layers generated by the subsequent painting process. Removal of the processing means 1 exposes the underlying adhesion region, against which the window pane 3 is then pressed. A structural weak point consisting, e.g., of a layer of filler and finishing lacquer between the adhesive 4 and the dip-primed surface of the flange 2 is thus eliminated. The result is a torsionally stiff overall structure in the sense of a lightweight construction with good crash properties. The processing means can be recycled and re-used, which saves operational costs.

At this juncture it should be pointed out that all the parts described above are claimed as essential to the invention individually or in any combination, in particular the details shown in the drawing. Modifications hereof are within the scope of a person skilled in the art.

### List of Reference Numerals

1 Processing means

2 Vehicle-body flange

3 Window pane

4 Adhesive

1. Processing means for masking regions of a vehicle during the painting operation, wherein
the processing means consists of a plastic material and can be placed on a cathodal dip-priming coat covering the flange around openings in a vehicle body or vehicle module, so as to produce a form-fitting seal.

2. Processing means according to claim 1, wherein the processing means consists of a thermally stable plastic that can be used at a long-term temperature of at least 170° C.

3. Processing means according to claim 1, wherein the processing means consists of a glass-fibre-reinforced polyamide.

4. Processing means according to claim 1, wherein the processing means is reinforced by fillers in a proportion from 0.1% to 40%.

5. Method of manufacturing and recycling processing means for masking regions of a vehicle during the painting process, comprising the following steps:
a) the processing means are produced by the injection moulding method;
b) after each time they are used, the processing means are ground up while still in the painted state; and
c) the resulting powder is returned as a raw material to be used again in the injection moulding process for producing processing means.

6. Method according to claim 5, for the injection moulding process in a recycling system, wherein an arbitrary proportion of original raw material is added.

7. Method according to claim 6, wherein the added quantity of original raw material amounts to about 10%.

8. Method of masking regions of a vehicle during the painting operation with a processing means according to claim 5, wherein the processing means is placed on a cathodal dip-priming coat covering a flange around openings in a vehicle body or vehicle module so as to produce a form-fitting seal, and after a final painting operation is removed again.

9. Method of employing the processing means according to claim 1 comprising masking module adhesion sites on a vehicle, in particular front flaps, rear flaps, mud guards, side walls or the like.
